(19) United States
(12) Patent Application Publication
(10) Pub. No.: US 2010/0164691 A1
(43) Pub. Date: Jul. 1, 2010

(54) DEVICE, METHOD AND SYSTEM FOR MONITORING, TRACKING AND THEFT PROTECTING OF OBJECTS TO BE SECURED

(76) Inventor: Marcel Martinus Dirk BERKHOUWER, MT Boskoop (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/517,348

(22) PCT Filed: Dec. 5, 2007
(86) PCT No.: PCT/NL07/00301

§ 371 Date: Dec. 2, 2009

(30) Foreign Application Priority Data
Dec. 5, 2006 (NL) 1032994
Jul. 16, 2007 (NL) 1034134

(51) Int. Cl. G06K 7/01; G06F 17/00

(52) U.S. Cl. 340/10.5; 235/375

(57) ABSTRACT

The invention relates to a security device for objects, for instance for products for the retail trade, comprising an active member and coupling means for attaching the active member to the product, wherein the active member comprises a memory element, such as an RHD chip, which is remotely at least readable and possibly also writable. The invention also relates to a product, system and method provided with a security device and a system of distribution and/or sale based on security devices and/or products.

The present invention relates to protection of objects, in particular though not exclusively products for the retail trade.

Examples of such products are articles of clothing, jewelry, brown and/or white goods, electronic products, cameras etc. It is emphasized here that these are only examples of the products to be secured.

It is usual to secure such objects or products with a tag. Two main types of tag are known.

The first type of tag known is that which is generally referred to as an EAS tag. An EAS tag is able and adapted to respond in the vicinity of an applied field, for instance an electromagnetic field, in order to make the proximity of this EAS tag known to a detector. The detector is in turn disposed in the vicinity of the field applied for instance with a generator. An alarm can be activated when the detector detects the presence of an EAS tag. Very generally known examples of such systems include ports at the exit to a shop, with which a field can be applied and which can therefore incorporate a detector for the purpose of detecting the proximity or presence of an EAS tag. Such a system therefore aims to actively catch people who attempt to remove products from a shop in unauthorized manner (without payment).

Such a tag makes no distinction between products on which they may be arranged. The possibilities of use of such an EAS tag are therefore exceptionally limited, particularly in respect of a complete distribution system which may precede sale in a shop. Theft can also occur here and it has been found, surprisingly, in various investigations that theft takes place to a greater extent outside shops, for instance during the distribution process, or by shop staff who have at their disposal the equipment for the removal of such an EAS tag.

Another generally known type of system makes use of ink cartridges. Such ink cartridges can be attached to products, such as articles of clothing, in similar manner as the other known EAS tags. The ink cartridges do not however serve to activate an alarm at the exit of a shop when such an ink cartridge tag has not been removed. If an attempt were made to remove a product in order to then remove the tag with the ink cartridge at another location, for instance at home, the attachment to the product will have to be forced. This unavoidably results in breakage of the ink cartridges, whereby the ink is released from the cartridge. This ink allegedly leaves an indelible stain. Such a tag based on an ink cartridge is therefore substantially effective because of the deterrent effect that the removed product is no use with either a visually very conspicuous ink cartridge on the product or an indelible stain.

Such a system based on an ink cartridge has substantially the same drawbacks as an EAS tag in respect of distribution and shoplifting by staff. It is moreover the case that—no matter how much of a deterrent the ink cartridges may be—an opportunity to catch a shoplifter at the exit to the shop is missed.

The present invention has for its object to obviate, or at least alleviate, the problems of the known art. A security device according to the present invention is distinguished for this purpose by the combination of features defined in claim number 1.

A memory element, in particular an RFID chip, has a unique identification code or can be programmed therewith. A specific security device can thus be tracked or traced. Information can herein be linked to a unique identification number relating for instance to the product on which a specific security device is arranged. It is thus possible to track in the various stages of distribution where possible theft has taken place, which will have a deterrent effect on potential thieves operating in the distribution process. An RFID chip can also be detected at the exit to a shop. This can be realized in various ways, this being the case for memory elements in general. A value corresponding to a successful financial transaction can thus be written at a certain memory position into a memory element which can be read remotely. This means that the alarm at the exit does not go off when a value has been written or stored in the memory element which indicates that the product in question has been paid for. According to the present invention a successful financial transaction can thus be linked to deactivation of the detection of the tag or the product at the exit to the shop.

Alternatively or additionally, the security device can be adapted for removal from the product, such as an item of clothing, though only when the successful financial transaction has taken place. It is thus possible to prevent shop assistants being able to steal a product simply by deactivating the coupling means. An extra security option can be that the coupling means act in combination with the content of a memory element. In an embodiment of the present invention it would then only be possible to remove the security device once a value corresponding to a successful financial transaction has been written into a relevant RFID chip or other memory element. Writing into the memory element at a transaction point such as a cash desk is however preferably avoided, although said option is certainly within the bounds of possibility.

It is further noted that a financial transaction in fact then includes any operation on the basis of which the security device can and may be deactivated, including an exchange without money changing hands.

The manufacturer of the security devices can be paid in suitable and accurate manner particularly in applications where the memory element is arranged by the manufacturer of products and only removed or deactivated at a cash desk following a successful financial transaction. It is possible to envisage payment per security device removed or deactivated at a cash desk. Particularly in applications where the security devices are removed at a cash desk—following a successful financial transaction—such a security device can be returned to the manufacturer thereof, or to the manufacturer of products on which these security devices can then be arranged once again in reusable manner. For all this type of application options it is the case that, just as in the distribution process, full traceability of the security device on its own can be realized. This enables accurate payment to the manufacturer of the security devices each time such a security device has completed a full cycle from the manufacturer of products to the shop and has been removed or deactivated close to the cash desk following a successful financial transaction.

Cash desk systems and the diverse links in the distribution chain can be provided for this purpose with detectors for reading the different memory elements. It is known particularly in the case of RFID elements that they can be read in large numbers and rapidly with a very high degree of reliability. At the various positions in the distribution process and at the cash desk in the retail premises it is thus possible to record exactly which products pass therethrough. An additional advantage here is that, if no values are written into the memory elements or the memory elements are not deactivated, it is still always possible to determine exactly which memory elements are located at any given moment at a determined position (for instance in the shop). This can be done simply by reading large numbers of memory elements simultaneously, and it is thus possible to obtain a very precise overview of the inventory of the retail establishment.

Particularly for the combination of a memory element, such as an RFID chip, with a security device based on ink cartridges, wherein the ink cartridge for instance forms the coupling means for the purpose of also arranging the RFID chip on a product, it is the case that there is a dual deterrent effect, particularly in respect of people who are shopping. On the one hand an alarm can go off at the exit to the shop and furthermore, if this can be circumvented in some way, it will still not be possible to use the product without a conspicuous ink cartridge thereon or an indelible ink stain thereon.

Various embodiments of security devices according to the present invention are possible, all falling within the scope of protection therefore as substantially defined in claim 1. Such preferred embodiments are set forth in the dependent claims. The present invention moreover also relates to products on which a security device according to the present invention is arranged, and distribution and cash desk systems with which it is possible to trace, and preferably remove or deactivate a specific memory element or RFID chip only when a successful financial transaction has been completed. This latter is substantially the subject matter of the claims 16-19 based on a method.

A number of exemplary embodiments of a security device according to the present invention will be described hereinbelow, in addition to a system in which such a security device can be used, also with specific reference to the method for uncoupling the security device from a product to be secured, for instance at a cash desk, where the financial transaction must take place with a consumer or end user.

The same or similar components and elements are designated in the various views of the figures with the same reference numerals. In the drawing:

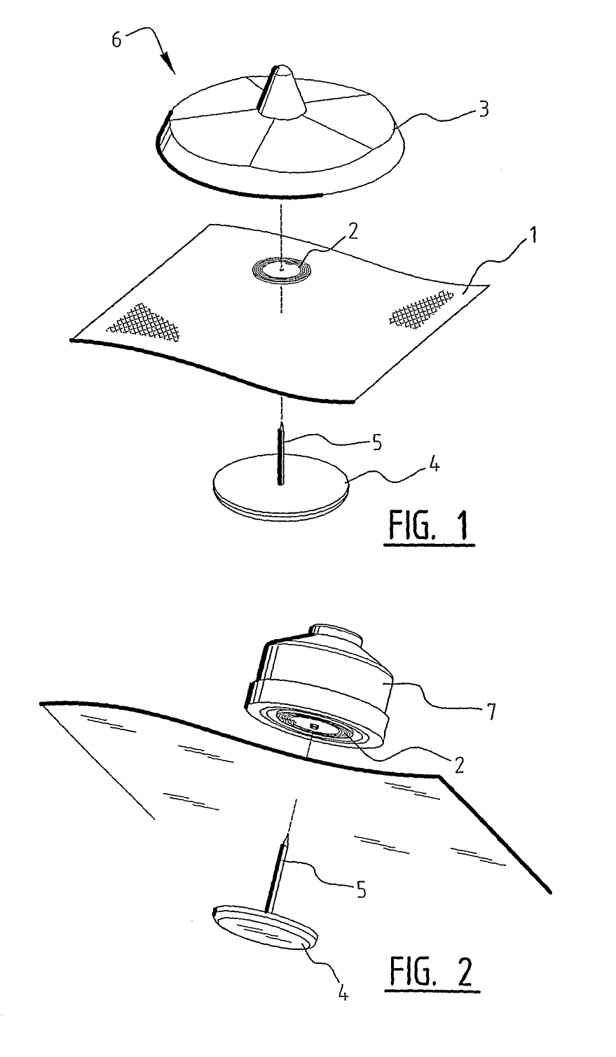

FIG. 1 shows a perspective view of a first embodiment of a security device according to the present invention;

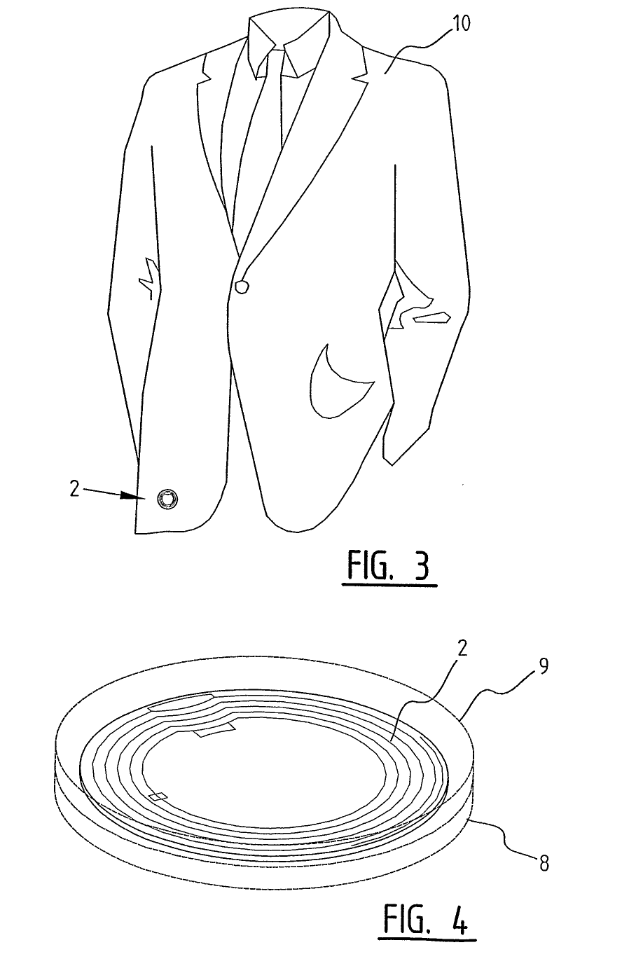

FIG. 2 shows a perspective view of a second embodiment of a security device according to the present invention;

FIG. 3 shows a front view of a product to be secured which takes the form of a jacket having thereon a security device in a third embodiment according to the present invention;

FIG. 4 is a perspective, partly cut-away view of a security device as shown in FIG. 3;

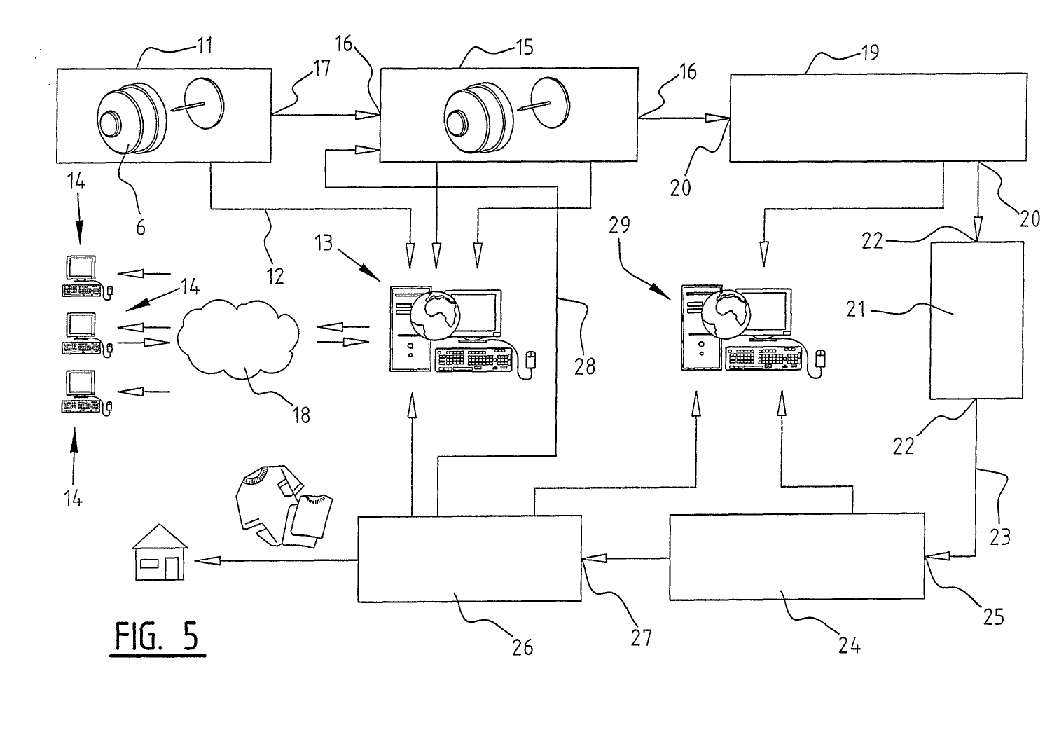

FIG. 5 shows a system adapted and suitable for the use of a security device according to the present invention for securing products, for instance in the retail trade; and

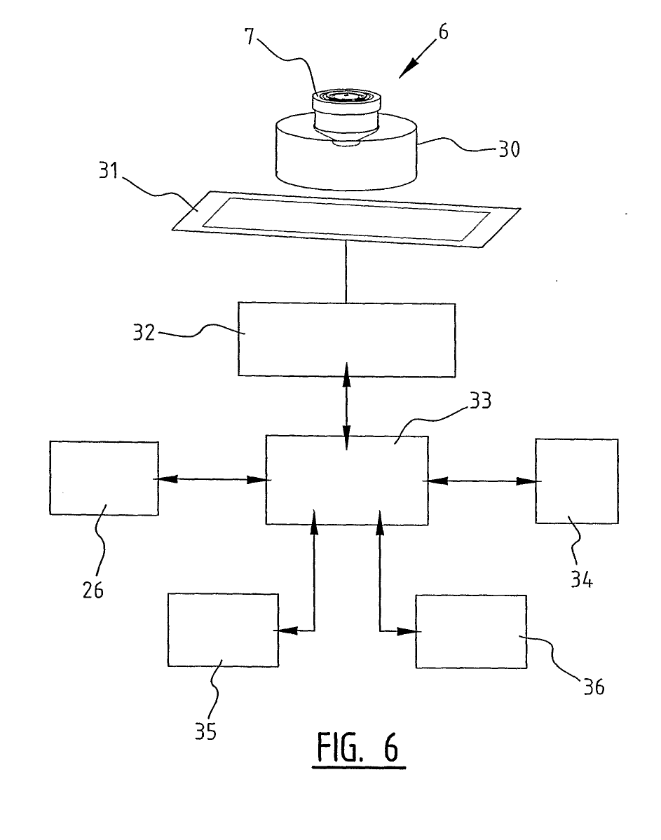

FIG. 6 shows a detail of the system of FIG. 5.

FIG. 1 shows a schematic and perspective view of a piece of fabric 1 forming part of a product to be secured, such as an item of clothing. For protection of fabric 1 use is made of a security device 6 according to the present invention. Security device 6 comprises an active member in the form of an RFID chip 2, and coupling means. In the embodiment shown in FIG. 1 the coupling means comprise a so-called EAS tag 3 which can be connected through fabric 1 to a counter-element 4 by means of an inserting pin 5 which forms a connection between counter-element 4 and EAS tag 3. In the embodiment shown here the coupling means according to the present invention are thus formed by EAS tag 3 in combination with counter-element 4 which can be coupled by means of inserting pin 5 to EAS tag 3.

RFID chip 2 is situated on the material or fabric 1 and is enclosed, closed and protected by EAS tag 3 and counter-element 4 when inserting pin 5 is inserted into EAS tag 3 with interposing of the fabric and RFID chip 2. It is noted that in an embodiment which is not shown the RFID chip 2 can have been or can be arranged on the side on fabric 1 directed toward counter-element 4.

FIG. 2 shows a similar embodiment, wherein use is made of an ink cartridge 7 as coupling means, wherein an RFID chip 2 is arranged on the underside of ink cartridge 7. It can be stated that RFID chip 2 is integrated into ink cartridge 7. It is noted that RFID chip 2 can have been or can be arranged or integrated in or on counter-element 4.

In the embodiment shown in FIG. 2 the RFID chip 2 is arranged on the underside of ink cartridge 7, although it is noted that the RFID chip can also be located in the interior of the ink cartridge, i.e. in the ink.

It is noted that, in addition to the embodiments shown in FIGS. 1 and 2, other coupling means can also be used for the purpose of arranging a memory element, in particular an RFID chip 2. It is important to note that in the shown embodiments use can however be made of systems which have proven themselves in practice and are based on the engagement of inserting pin 5 in ink cartridge 7 or in EAS tag 3, which engagement can only be released in the presence of a very specific field, for instance a magnetic field, for the purpose of ending the engagement. It is thus possible to ensure that, due to the safe enclosure and protection of RFID chip 2, this latter cannot be externally affected. Owing to the reliable enclosure thereof, damage to RFID chip 2 can for instance be prevented to a large extent. If an attempt should be made to release the coupling, this will at least result in damage to the product on which the security device according to the present invention is arranged, either as a result of damage to the fabric or material 1 when detaching the security device 6 therefrom, or because ink cartridge 7 in FIG. 2 bursts open.

FIG. 3 shows another embodiment wherein use is not made of a coupling which can be deemed per se as conventional security device.

In FIG. 3 use is made of RFID chip 2 as embodiment of a memory element. RFID chip 2 is arranged on a carrier 8 which can be formed as a sticker, label, disc or other substrate which can serve in appropriate manner for the purpose of arranging the RFID chip thereon. A layer of adhesive 9 is applied over RFID chip 2 and to the upper surface of carrier 8. This adhesive forms the coupling means according to the present invention. RFID chip 2 on carrier 8 can be arranged by means of adhesive 9 on an article of clothing, for instance jacket 10 in FIG. 3, which is an embodiment of a product to be secured.

Adhesive 9 can be a very specific adhesive. It may for instance display an adhesive action only under very specific conditions, for instance by having a very specific influence act thereon. An electromagnetic field can for instance be applied. Such an electromagnetic field can activate and/or deactivate the adhesive 9 on the basis of for instance a predetermined polarization of the field, a predetermined frequency or sequence of frequencies or other properties of the influence acting on adhesive 9.

Referring further to embodiments shown in FIGS. 3 and 4, it can be noted that an RFID chip 2 or other memory element, or at least an antenna thereof, can be printed with conductive ink on a product to be protected. In such an embodiment the coupling means according to the present invention are therefore formed by the product to be secured itself and the memory element itself. In yet another preferred embodiment based on the same principle an RFID chip, or at least the antenna thereof, can be interwoven in material of a product to be secured, for instance a fabric or a material. In such an embodiment it is recommended that the memory element, in particular RFID chip 2, be deactivated in the case of a valid financial transaction, for instance by applying a field pulse of a sufficient force to burn out, or at least deactivate, the antenna or the memory element itself. This is of course also possible by writing an appropriate value into the memory space of the memory element.

FIG. 4 shows the embodiment wherein use is made of an adhesive. This adhesive must be so strong under normal conditions that the RFID element cannot be removed from the article of clothing 10 without causing damage to article of clothing 10. It is however essential here, when a valid financial transaction has taken place, to remove the memory element in the form of RFID chip 2, particularly if reuse thereof is desired or necessary. It would be a pity to allow RFID chips 2 to be lost if they are or can easily be made reusable.

Use can be made of diverse techniques for reuse of a memory element or RFID chip 2. The memory space of the memory element can for instance be erased and provided with new values. Such values can be related to the reuse, or an old set of values relating to another product on which the memory element may previously have been arranged must then at least be updated.

FIG. 5 shows a system suitable for applying and/or using security devices with memory elements, in particular an RFID chip 2. The RFID chip 2 is however mentioned in all cases only by way of example. Other memory elements which are remotely readable and perhaps also rewritable can also be applied according to the present invention.

FIG. 5 shows a distribution and sales system in which a security device according to the present invention can be applied.

Security devices 6 according to the present invention are produced at location 11. A scanner 17 is disposed at the exit to location 11. Scanner 17 is adapted to provide information concerning the produced security devices 6 via communication line 12 to a central computer, for instance for the purpose of updating a database. Central computer 13 is adapted to communicate, if desired via the internet 18, with individual computers 14.

From the location 11 for producing security devices 6 the security devices 6 are physically transported to a storage 15 with scanners 16 at the entrance and at the exit. Scanners 16 are adapted and suitable to transmit to central computer 13 information relating to incoming security devices and outgoing security devices 6.

From the exit of storage 15 the security devices 6 are moved physically to a clothing manufacturer 19. The clothing manufacturer also has a number of scanners 20 at the entrance and at the exit to production facility 19. Prior to exiting production location 19 of the clothing manufacturer the security devices 6 according to the present invention are arranged on articles of clothing or other products to be secured. From the exit to production location 19 the security devices on the products to be secured are optionally moved to a storage 21, once again having scanners 22 at the entrance and at the exit.

The products to be secured are then transported 23 with security devices 6 according to the present invention on these products. Having arrived at a shop 24, the arrival of the products to be secured is recorded at the entrance to shop 24 by means of a scanner 25, on the basis of which the inventory in the shop can be kept at a desired level. If desired, scanners can be used to also monitor the stock on racks or stands. If a product to be secured and a secured product is presented at a cash desk 26, a scanner is then first used to identify the product on the basis of data which can be obtained from security device 6 according to the present invention. If security devices 6 are physically removed from the products to be secured, they are then transported along route 28 back to the storage of the manufacturer of the security devices so that invoicing can take place relating to the route covered through the distribution chain. Data can also be once again transferred to central computer 13 relating to the successful sale.

It is also noted that a second central computer 29 can be applied, particularly by manufacturers of products to be secured at production location 19 and individual retail premises 24 or shops in order to keep stock up to a desired level. This is because cash desk sales result in a reduction of stock, and this can be transmitted to the second central computer 29 in order to place an automatic order on the basis thereof, or to await a determined authorization to this effect from the manager of the retail premises.

The protected products leave cash desk 26 in unprotected state with the customer.

Because of possible problems with user groups which may object to the traceability of an RFID chip 2, it is recommended to wholly remove the RFID chips 2 and security devices 6 from the clothing and return them to a desired point of reuse, which may also be the production location 19 of a manufacturer other than shown in FIG. 5 (where security devices 6 are returned to the manufacturer of the security devices themselves).

In a possible alternative embodiment the memory elements, in particular RFID chips 2, can be disabled in order to anticipate these possible problems with user groups. In yet another embodiment a value can simply be written into the RFID chips or other memory elements in order to make future traceability thereof impossible. In view of the technical complexity and the cost of RFID chips 2, it is however recommended that security devices with a memory element according to the present invention are reused.

FIG. 6 shows a detail of the system of FIG. 5. This is a detail of the system which is associated with cash desk 26. This detail of FIG. 6 relates specifically to an embodiment within the scope of the present invention on the basis of which it is possible to then detach a security device 6, particularly with an ink cartridge 7, only when a valid financial transaction has been completed with certainty in relation to the product on which safety device 6 is arranged.

The detail of FIG. 6 comprises for this purpose a disconnector 30 having therein an electromagnet as an embodiment of a selectively controllable and actuable magnetic system. This is per se known and can be energized selectively for the purpose of removing security device 6 from the product secured therewith. An RFID antenna 31 is disposed in the vicinity of disconnector 30. This antenna is placed under magnet 30 in FIG. 6, but could be arranged above or round magnet 30. An integrated design of magnet 30 and the antenna in one combined embodiment can then also be provided and included in the scope of protection of the present invention.

The information content of security device 6 can be read using this RFID antenna 31. This is then particularly the information content of the security device 6 presented in the vicinity of RFID antenna 31 for the purpose of uncoupling security device 6 from the thus secured product using disconnector 30. Information is for instance obtained with RFID antenna 31 relating to the product from which security device 6 must be removed, or of locations and/or other data. This information is extracted using an RFID reader 32. The thus obtained information is presented by RFID reader 32 to a microprocessor 33 or a separate computer. Microprocessor 33 is connected, for instance via a sequential computer interface, to cash desk 26. Conversely, microprocessor 33 is connected to an electronic circuit 34 with which disconnector 30, and in particular the electromagnet therein, can be operated or energized. This energizing can take place on the basis of the content read from the transponder, using which content a decision can be taken as to whether or not the microprocessor may be set into operation in order to activate the electromagnet.

A comparison can be made quite simply as such using microprocessor 33 as to whether a product with a security device 6 presented at disconnector 30 is the same product as one for which a signal is given by cash desk 26 to microprocessor 33 that a valid financial transaction has been completed. Only when it has been determined by microprocessor 33 that a valid financial transaction has been successfully completed, and this for the product which is presented at disconnector 30 for removal of security device 6 therefrom and the identity of which is found by reading of the memory module in security device 6 by the RFID antenna, and the provision of such an entity via RFID reader 32 to microprocessor 33, will microprocessor 33 generate a signal to the electronic circuit 34 in order to also actually energize disconnector 30 and thus remove security device 6 from the secured product.

If on the basis of the identification of the product presented at disconnector 30 the microprocessor concludes that a valid financial transaction has not been completed successfully herefor, disconnector 30 will not be set into operation via electronic circuit 34 or in any other way. If it is however apparent that for the product in question at disconnector 30 on which security device 6 is arranged a valid payment has been received, electronic circuit 34 will be controlled in order to remove security device 6 with disconnector 30. If desired, a bar code which can be arranged separately on the product can also be read, and the indication appearing thereon can be compared to the content of the memory element according to the invention, and the disconnector is then activated only if the product is really related to the financial transaction. If the transaction is successful, the memory element can be blocked against renewed writing therein until the security device is or has been returned to a party in the distribution chain authorized to this effect, such as a manufacturer of the products to be secured.

Diverse other information can here also be processed in microprocessor 33. Use can for instance be made of a fingerprint reader 35 in order to establish and possibly register the identity of cash desk staff who have supervised the transaction. Any other means of establishing identity can also be applied as alternative, such as an ID card and reader or the like. It is thus possible to find out who was responsible at the moment a possible discrepancy occurred, although such discrepancies are already avoided to a large extent using the system with a detail as according to FIG. 6. Another option therefore is that an identity card is then issued to cash desk staff, and cash desk 26 can only be operated when the identity of the cash desk staff has been determined with either of the fingerprint reader 35 or ID card reader 36.

Transaction data are normally stored. Such transaction data can include the identity of the secured product, as well as the financial transaction completed in respect thereof. The data can also be recorded here relating to the identity of an individual member of the cash desk staff who at a specific moment in time made use of or was responsible for operation of the cash desk system with the detail shown in FIG. 6. It is substantially the case that security devices 6 are arranged on products, which are thus secured. Using RFID antenna 31 and RFID reader 32 an identification of the relevant product can be provided to the microprocessor, this on an individual basis. The disconnector 30 will however then only be energized to remove the security device when cash desk 26 gives a signal to microprocessor 33 which shows that payment has actually also been made for this relevant product with security device 6 thereon. It can additionally or alternatively be determined here, optionally once again, whether a specific individual product presented for the purpose of uncoupling the security device therefrom may be situated at this shop location in the light of the preceding distribution chain.

After examination of the foregoing, many alternative and additional embodiments will occur to the skilled person, all of which must be deemed as lying within the scope of protection of the present invention, unless such additional and alternative embodiments clearly depart from the letter and/or the spirit of the appended claims. It is thus possible for a memory element other than an RFID chip to be used, such as another type of RF transponder. A memory element such as an RFID chip can further be arranged or integrated in, on or onto a counter-element of a conventional EAS tag or a security device based on an ink cartridge instead of on, in or onto the ink cartridge or the EAS tag itself. Various additional measures can be taken to secure the communication with an RFID chip or other memory element. The coupling means can be releasable in conventional manner or in wholly novel manner, this particularly being demonstrated for instance with the layer of adhesive in for instance FIG. 4, which is adapted and designed to release only under very specifically determined conditions. It is thus possible to ensure that a memory element is disabled or removed from the secured product only in the case of a successful financial transaction.

1. Security device for objects, for instance for products for the retail trade, comprising:
an active member; and
coupling means for attaching the active member to the product,
wherein the active member comprises a memory element, such as an RFID chip, which is remotely at least readable and possibly also writable or rewritable.

2. Security device as claimed in claim 1, wherein the coupling means comprise an ink cartridge.

3. Security device as claimed in claim 1 or 2, wherein the coupling means comprise an EAS transponder.

4. Security device as claimed in at least one of the foregoing claims, wherein the coupling means comprise a counter-element.

5. Security device as claimed in at least claim 4, wherein one of the counter-element and the active member comprises a connection to be selectively engaged by the other of the counter-element and the active element, with which pin the active member and the counter-element can be connected with interposing of a part of the product.

6. Security device as claimed in claim 5, wherein the connection comprises an inserting pin.

7. Security device as claimed in at least one of the foregoing claims, wherein the coupling means comprise an adhesive to be selectively deactivated.

8. Security device as claimed in claim 7, wherein the adhesive is applied to a carrier for the memory element.

9. Security device as claimed in claim 7 or 8, wherein the adhesive can be the activated using only a predefined influence, such as:
an electromagnetic field with at least one of: a predetermined polarization; a predetermined frequency; and so forth.

10. Security device as claimed in at least one of the foregoing claims, wherein the coupling means comprise: the product to be secured and the memory element itself.

11. Security device as claimed in at least one of the foregoing claims, wherein the memory element has a pattern such as an RFID chip which can be incorporated in a fabric of a product.

12. Security device as claimed in at least one of the foregoing claims, wherein the coupling means comprise a conductive ink.

13. Security device as claimed in claim 12, wherein a pattern arranged in the conductive ink on a product to be secured forms an integral part of the memory element, such as the antenna section of an RFID chip.

14. Product provided with a security device as defined in at least one of the foregoing claims.

15. System of distribution and/or sale based on security devices and/or products as claimed in at least one of the foregoing claims.

16. Method for the removal of a security device with an active member with a memory element, such as an RFID chip, which is remotely at least readable and possibly also writable or rewritable, and optionally in combination with an ink cartridge, and with coupling means which form a selectively releasable attachment of the security device to a product to be secured, and by means of a disconnector acting selectively on the coupling means, at least comprising the steps of: verifying that a valid financial transaction has been completed for the product associated with the security device; and, in response to a valid financial transaction in respect of the product to be secured, enabling the action of the disconnector on the coupling means in order to detach the security device from the product to be secured.

17. Method as claimed in claim 16, further comprising the steps of tracing at least the security device in at least a part of a distribution chain having therein at least one of a number of possible locations for intended uncoupling, such as retail premises, and then activating the disconnector only in response to the determination that the product with the associated security device thereon is situated at a relevant location for intended uncoupling.

18. Method as claimed in claim 16 or 17, comprising the step of verifying that the product associated with the security device corresponds with the designation thereof in the memory element and with the financial transaction.

19. Method as claimed in claim 18, comprising the step of reading data related to the product to be secured from a separate product indication, such as a bar code, on the product to be secured, and verifying that these data related to the product correspond with the information in the memory element of the security device.

20. Method as claimed in at least one of the foregoing claims 16-19, further comprising of blocking the memory element against rewriting therein after a successful financial transaction, at least until the security device has been returned to a party in the distribution chain preceding uncoupling of the security device, such as a manufacturer.
